(19) United States
(12) Patent Application Publication
(10) Pub. No.: US 2026/0262719 A1
(43) Pub. Date: Sep. 10, 2026

(54) ATOMIZER AND ELECTRONIC ATOMIZATION DEVICE

(71) Applicant: VERDEWELL INTERNATIONAL HOLDINGS LIMITED, George Town (KY)

(72) Inventors: Xiaojun ZHONG, Shenzhen (CN); Yaqiao WANG, Shenzhen (CN); Qi LI, Shenzhen (CN); Ju XIE, Shenzhen (CN)

(73) Assignee: VERDEWELL INTERNATIONAL HOLDINGS LIMITED, George Town (KY)

(21) Appl. No.: 19/658,345

(22) Filed: Apr. 24, 2026

Related U.S. Application Data
(63) Continuation of application No. PCT/CN2024/121977, filed on Sep. 27, 2024.

(30) Foreign Application Priority Data
Oct. 24, 2023 (CN) 202311392536.8
Oct. 24, 2023 (CN) 202322862154.9

(51) Int. Cl. A24F 40/42; A24F 40/10; A24F 40/485; A24F 40/50; H05B 3/03

(52) U.S. Cl. CPC A24F 40/42; A24F 40/10; A24F 40/485; A24F 40/50; H05B 3/03

(57) ABSTRACT

An atomizer includes: a housing having a liquid storage cavity formed therein; a first atomization base at least partially disposed in the housing; a second atomization base disposed in the housing, an atomization cavity being formed between the second atomization base and the first atomization base; and an atomization core at least partially disposed in the atomization cavity. At least one first liquid storage groove is formed on the first atomization base, and at least one first liquid storage groove is located below the atomization cavity.

### CROSS-REFERENCE TO PRIOR APPLICATION

This application is a continuation of International Patent Application No. PCT/CN2024/121977, filed on Sep. 27, 2024, which claims priority to Chinese Patent Application Nos. 202322862154.9, filed on Oct. 24, 2023 and 202311392536.8, filed on Oct. 24, 2023. The entire disclosure of the foregoing applications is hereby incorporated by reference herein.

### FIELD

This application relates to the field of atomization technologies, and more specifically, to an atomizer and an electronic atomization device.

### BACKGROUND

An electronic atomization device generally includes an atomizer and a power supply device. The power supply device is configured to supply power to the atomizer. The atomizer usually includes a liquid storage cavity, an atomization cavity, and an atomization core. The liquid storage cavity is configured to store a liquid substrate.

In an existing structure of the atomizer, the atomization core is partially disposed in the atomization cavity, and the liquid substrate is supplied from the end of the atomization core to the middle. Therefore, a small amount of the liquid substrate flows downward during inhalation, causing liquid leakage during drawing.

### SUMMARY

In an embodiment, the present invention provides an atomizer, comprising: a housing having a liquid storage cavity formed therein; a first atomization base at least partially disposed in the housing; a second atomization base disposed in the housing, an atomization cavity being formed between the second atomization base and the first atomization base; and an atomization core at least partially disposed in the atomization cavity, wherein at least one first liquid storage groove is formed on the first atomization base, and wherein the at least one first liquid storage groove is located below the atomization cavity.

### BRIEF DESCRIPTION OF THE DRAWINGS

To describe the technical solutions in the embodiments of this application more clearly, the following briefly introduces the accompanying drawings for describing the embodiments or the exemplary technology Apparently, the accompanying drawings in the following description show merely some embodiments of this application, and a person of ordinary skill in the art may still derive other drawings from the accompanying drawings without creative efforts.

FIG. 1 is a side view of an electronic atomization device according to some embodiments of this application;

FIG. 2 is a schematic three-dimensional structural diagram of an atomizer in FIG. 1;

FIG. 3 is a schematic longitudinal sectional structural diagram of the atomizer shown in FIG. 2;

FIG. 4 is a cross-sectional view of a partial structure of the atomizer in FIG. 2;

FIG. 5 is a schematic exploded structural view of the atomizer shown in FIG. 2;

FIG. 6 is a schematic three-dimensional structural diagram of a sealing member in FIG. 5; and

FIG. 7 is a schematic three-dimensional structural diagram of a base in FIG. 5.

### DETAILED DESCRIPTION

In an embodiment, the present invention provides an improved atomizer and an electronic atomization device having the atomizer for the above shortcoming in the existing technology.

In an embodiment, the present invention provides an atomizer, including:
a housing, where a liquid storage cavity is formed in the housing;
a first atomization base at least partially disposed in the housing;
a second atomization base disposed in the housing, where an atomization cavity is formed between the second atomization base and the first atomization base; and
an atomization core, at least partially disposed in the atomization cavity, where
at least one first liquid storage groove is formed on the first atomization base, and the at least one first liquid storage groove is located below the atomization cavity.

In some embodiments, the first atomization base includes two abutting portions, two ends of the atomization core are respectively disposed on the two abutting portions, and two surfaces of the two abutting portions that are disposed opposite to each other define a part of a boundary of the at least one first liquid storage groove.

In some embodiments, a depth of the at least one first liquid storage groove ranges from 1 mm to 3 mm.

In some embodiments, the first atomization base further includes an annular protrusion located between the two abutting portions, the inner wall surface of the annular protrusion defines a vent hole in communication with the atomization cavity, and the outer wall surface of the annular protrusion defines the part of the boundary of the at least one first liquid storage groove.

In some embodiments, the first atomization base includes a base and a sealing sleeve sleeved on the base, and the at least one first liquid storage groove is formed on the sealing sleeve.

In some embodiments, a second liquid storage groove and an air inlet that communicates the vent hole with the outside are formed on the base.

In some embodiments, the second liquid storage groove surrounds outside the air inlet, and a height of the air inlet protruding from a bottom surface of the second liquid storage groove is greater than or equal to a depth of the second liquid storage groove.

In some embodiments, a projection of at least a partial inner contour of a cross section of the annular protrusion on the base in a vertical direction is located in the second liquid storage groove.

In some embodiments, the annular protrusion includes two side walls disposed opposite to each other in an axial direction of the atomization core, each side wall includes a middle part and two edge parts respectively located at two ends of the middle part, a height of the middle part is less than a height of the edge parts, and the projection of the inner wall surface of the middle part on the base is located in the second liquid storage groove.

This application further provides an electronic atomization device, including the atomizer and a control circuit electrically connected to the atomizer.

Implementation of this application has at least the following beneficial effects: by disposing a first liquid storage groove below an atomization cavity, when liquid leakage occurs in an atomization core, a leaked liquid can be caught by the first liquid storage groove, thereby reducing liquid leakage during inhalation.

In the descriptions of this application, it should be understood that, orientation or position relationships indicated by terms such as “longitudinal”, “transverse”, “upper”, “lower”, “top”, “bottom”, “inner”, “outer”, and “below”, are orientation or position relationships shown based on the accompanying drawings or orientation or position relationships that the product of this application is usually placed in use, and are merely used for describing this application and simplifying the description, rather than indicating or implying that the mentioned device or element needs to have a particular orientation or needs to be constructed and operated in a particular orientation. Therefore, such terms should not be construed as a limitation on this application.

In addition, the terms “first” and “second” are used for descriptive purposes only and are not to be construed as indicating or implying relative importance or to implicitly indicate the number of technical features indicated. Therefore, features defined with “first” or “second” may explicitly or implicitly include at least one of such features. In the descriptions of this application, “a plurality of” means at least two, for example, two or three, unless otherwise explicitly and specifically limited.

In this application, unless otherwise explicitly specified and limited, the terms such as “mount”, “connect”, “connection”, and “fix” should be understood in a broad sense. For example, a connection may be a fixed connection, a detachable connection, or an integral connection; the connection may be a mechanical connection or an electrical connection; or the connection may be a direct connection, an indirect connection through an intermediary, internal communication between two elements, or interaction between two elements, unless otherwise explicitly defined. A person of ordinary skill in the art may understand the specific meanings of the foregoing terms in this application according to specific situations.

In this application, unless otherwise explicitly specified and limited, that a first feature is “on” or “below” a second feature may mean that the first and second features are in direct contact, or may mean that the first and second features are in indirect contact by using an intermediary. In addition, that the first feature is “on” or “above” the second feature may mean that the first feature is directly above or obliquely above the second feature, or may merely mean that the horizontal height of the first feature is greater than that of the second feature. That the first feature is “below” or “under” the second feature may mean that the first feature is directly below or obliquely below the second feature, or may merely mean that the horizontal height of the first feature is less than that of the second feature.

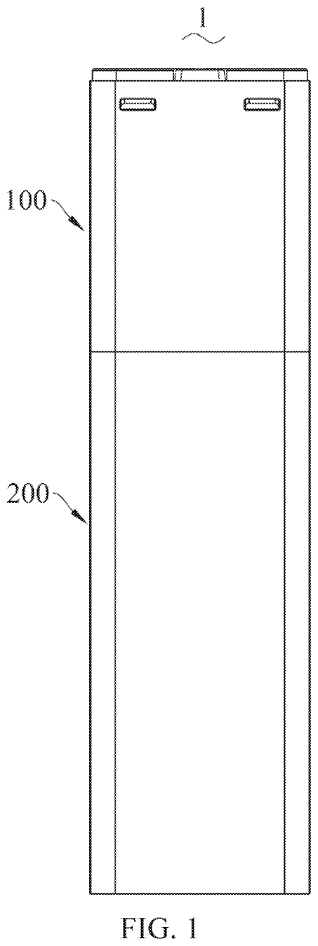

FIG. 1 shows an electronic atomization device 1 according to some embodiments of this application. The electronic atomization device 1 includes an atomizer 100 and a power supply device 200 connected to the atomizer 100 in a matched manner. The power supply device 200 usually includes a battery for supplying power to the atomizer 100 and a control circuit for controlling the atomizer 100 to generate heat. The atomizer 100 is configured to accommodate a liquid substrate, and heat and atomize the liquid substrate after being powered on to generate an aerosol. The liquid substrate includes, but is not limited to, materials used for medical, nutrient, health, and cosmetic purposes.

In some embodiments, both the atomizer 100 and the power supply device 200 may be approximately rectangular prisms, and may be mechanically and electrically connected to each other in an axial direction. Further, the atomizer 100 and the power supply device 200 may be connected in a detachable manner such as magnetic connection, threaded connection, and a snap fit. Certainly, in other embodiments, the atomizer 100 and the power supply device 200 may alternatively be connected in a non-detachable manner. In addition, the cross-sectional shape of the atomizer 100 and/or the cross-sectional shape of the power supply device 200 is not limited to be a rectangle, and may alternatively be a circle, a racetrack, an ellipse, or other shapes.

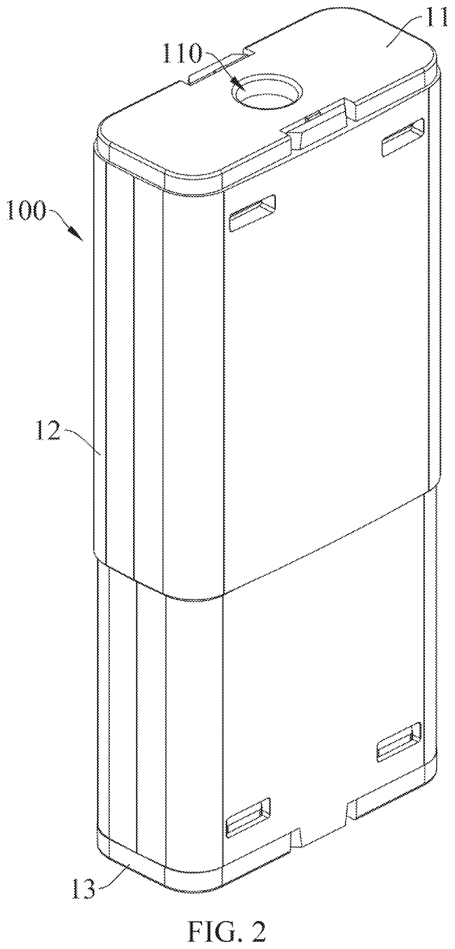

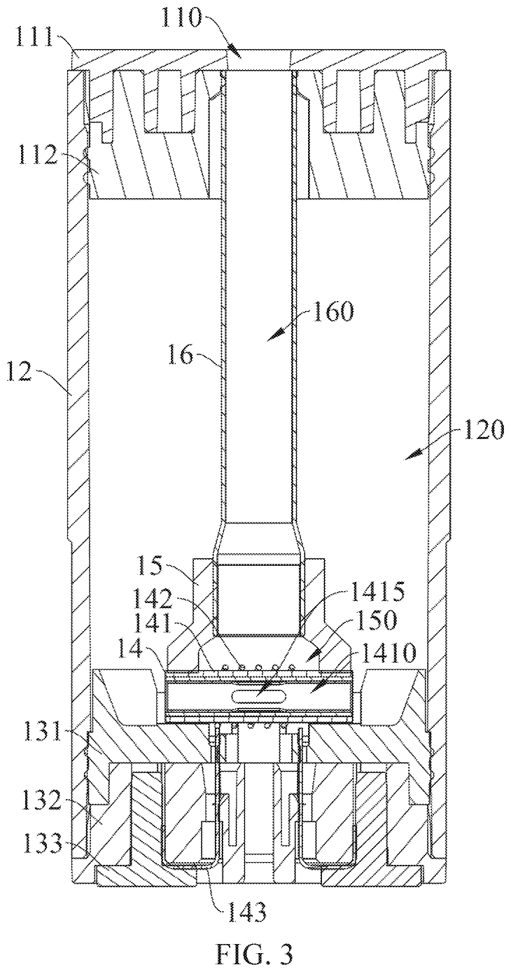

As shown in FIG. 2 and FIG. 3, the atomizer 100 may include a housing 12 and an atomization core 14 disposed in the housing 12. A liquid storage cavity 120 and an air outlet channel 160 that are separated are formed in the housing 12. The atomization core 14 is in liquid guide communication with the liquid storage cavity 120 and in air guide communication with the air outlet channel 160, and is configured to heat and atomize a liquid substrate in the liquid storage cavity 120 after being powered on, to generate an aerosol. The aerosol is then output through the air outlet channel 160 to be inhaled by a user.

In some embodiments, the housing 12 may be in a cylindrical shape with two ends open. The atomizer 100 may further include a suction nozzle cover 11 and a first atomization base 13 that are respectively disposed at two ends of the housing 12, and an air outlet tube 16 and a second atomization base 15 that are disposed in the housing 12. The suction nozzle cover 11 covers the upper end of the housing 12, and an inhalation channel 110 that communicates the air outlet channel 160 with the outside is formed by extending through the suction nozzle cover 11. The first atomization base 13 covers the lower end of the housing 12, and may be configured to support and mount the atomization core 14. The air outlet tube 16 is disposed longitudinally in the housing 12 and may be coaxially disposed with the housing 12, but is not limited to being coaxially disposed. The inner wall surface of the air outlet tube 16 defines the air outlet channel 160, and the outer wall surface of the air outlet tube 16 and the inner wall surface of the housing 12 define the liquid storage cavity 120.

Specifically, the suction nozzle cover 11 may include a suction nozzle portion 111 and a sealing portion 112 that are embedded in each other. The sealing portion 112 is at least partially embedded in an upper end opening of the housing 12, and the sealing portion 112 may be made of an elastic material such as silicone. The sealing portion 112 made of an elastic material can provide a good sealing effect for the liquid storage cavity 120, and moreover, can further facilitate pluggable assembly and disassembly between the suction nozzle cover 11 and the housing 12, so that the suction nozzle cover 11 can be conveniently removed from the housing 12 for adding the liquid substrate to the liquid storage cavity 120. Certainly, in the atomizer 100, a liquid may alternatively be added to the liquid storage cavity 120 in another known manner. Alternatively, the atomizer 100 may be disposable, that is, the atomizer 100 is discarded after the liquid substrate is consumed. The suction nozzle portion 111 may be made of a hard material such as plastic, helping improve the structural strength of the suction nozzle cover 11.

Certainly, in other embodiments, the suction nozzle cover 11 may alternatively be of an integral structure made of only one material such as plastic or silicone. In some other embodiments, the suction nozzle cover 11 and the housing 12 may alternatively be integrally formed. For example, the suction nozzle cover 11 and the housing 12 are integrally formed by injection molding.

The upper end of the air outlet tube 16 may be embedded in the sealing portion 112 and in communication with the inhalation channel 110. The outer wall surface of the air outlet tube 16 may be in a sealing fit with the inner wall surface of the sealing portion 112 through an interference fit, thereby well sealing and isolating the air outlet channel 160 from the liquid storage cavity 120. In other embodiments, the air outlet tube 16 may alternatively be integrally formed with the suction nozzle cover 11. For example, the air outlet tube 16 may be integrally formed by the top wall of the suction nozzle portion 111 extending downward.

The first atomization base 13 is at least partially disposed in a lower end opening of the housing 12. The second atomization base 15 is disposed above the first atomization base 13. An atomization cavity 150 is formed through cooperation between the first atomization base 13 and the second atomization base 15. The atomization cavity 150 is in communication with the air outlet channel 160. The atomization core 14 is at least partially disposed in the atomization cavity 150.

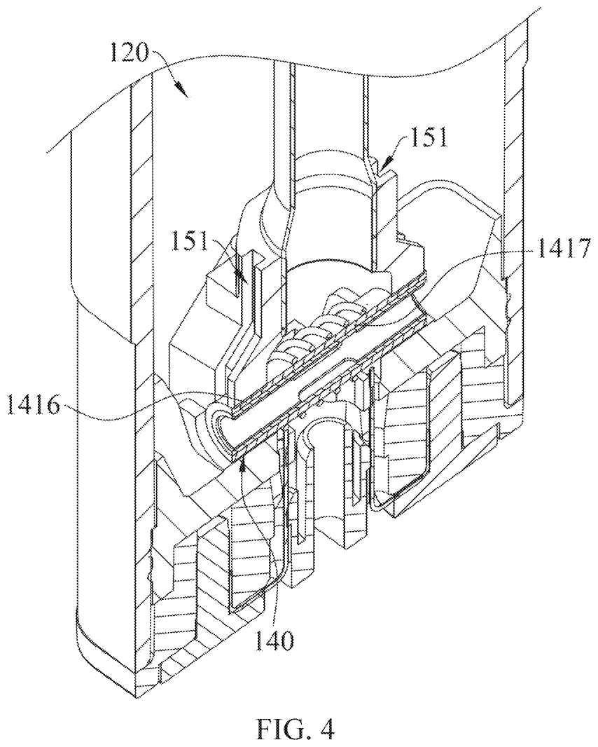

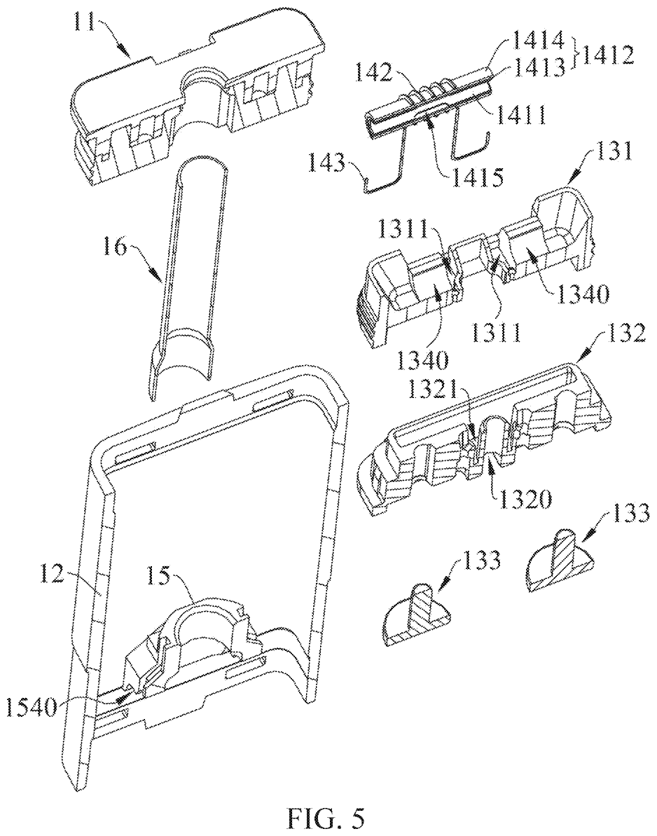

With reference to FIG. 3 to FIG. 5, the atomization core 14 is transversely disposed in the housing 12. The axis direction of the atomization core 14 may be perpendicular to the axis direction of the housing 12. At least one end of the atomization core 14 is in communication with the liquid storage cavity 120. Two ends of the atomization core 14 may be pressed between the first atomization base 13 and the second atomization base 15, thereby mounting and limiting the atomization core 14.

In some embodiments, two pressing grooves 1340 may be formed by recessing downward on the top surface of the first atomization base 13, and two pressing grooves 1540 are formed by recessing upward on the bottom surface of the second atomization base 15. The two pressing grooves 1340 respectively cooperate and communicate with the two pressing grooves 1540 to form two clamping slots 140, and the two clamping slots 140 are respectively configured to accommodate and fix the two ends of the atomization core 14.

The atomization core 14 may include a liquid guide portion 141 and a heating portion 142 in contact with the liquid guide portion 141. The liquid guide portion 141 is at least partially disposed in the atomization cavity 150 and is in communication with the liquid storage cavity 120, and is configured to draw the liquid substrate from the liquid storage cavity 120. The heating portion 142 is located in the atomization cavity 150 and may be in contact with the outer wall surface of the liquid guide portion 141, and is configured to heat and atomize a liquid substrate on the liquid guide portion 141 after being powered on. Further, the atomization core 14 further includes two electrode leads 143 respectively connected to two ends of the heating portion 142, and the heating portion 142 is connected to an external power supply through the two electrode leads 143.

The liquid guide portion 141 includes two pressing portions 1416 and an atomization portion 1417 located between the two pressing portions 1416. The atomization portion 1417 is located in the atomization cavity 150. The heating portion 142 is disposed on the outer wall surface of the atomization portion 1417. In some embodiments, the heating portion 142 may be a metal heating wire wound around the atomization portion 1417.

The two pressing portions 1416 are respectively accommodated in the two clamping slots 140. The shape and the size of the clamping slot 140 respectively match the shape and the size of the pressing portion 1416, so that the atomization core 14 can be better accommodated and fixed. In this embodiment, the pressing portion 1416 is in a circular tube shape. Correspondingly, the pressing grooves 1340 and the pressing grooves 1540 each are in a circular arc shape and are in communication to form a cylindrical clamping slot 140. Certainly, in other embodiments, the pressing portion 1416 and the clamping slot 140 may alternatively in other shapes. In some other embodiments, the quantities of the pressing portions 1416 and the clamping slots 140 are also not limited, which may be one or more than two. In addition, the clamping slot 140 is not limited to an end position for fixing the atomization core 14, that is, the pressing portion 1416 is not limited to being located at an end position of the liquid guide portion 141.

In some embodiments, the liquid guide portion 141 is in a tube shape, and a liquid guide channel 1410 is formed extending through the liquid guide portion 141. The liquid guide channel 1410 may be coaxially disposed with the liquid guide portion 141, but is not limited to being coaxially disposed. Both ends of the liquid guide channel 1410 in the axial direction are in communication with the liquid storage cavity 120, so that the liquid substrate in the liquid storage cavity 120 can enter the liquid guide channel 1410 through the two ends of the liquid guide portion 141, and further be guided to the heating portion 142 through the liquid guide portion 141 to be heated.

Certainly, in other embodiments, the liquid guide channel 1410 may alternatively be in communication with the liquid storage cavity 120 at only one end. In addition, the part of the liquid substrate in the liquid storage cavity 120 may alternatively not be guided to the liquid guide portion 141 through the liquid guide channel 1410, but is directly drawn by the part of the liquid guide portion 141 that extends into the liquid storage cavity 120 or that is in communication with the liquid storage cavity 120.

In some embodiments, the liquid guide portion 141 may include a support member 1411 and a liquid guide layer 1412 sleeved on the support member 1411. The support member 1411 is in a tube shape, for example, a circular tube shape. The liquid guide channel 1410 may extend through two ends of the support member 1411 in the axial direction. At least one liquid guide hole 1415 is provided extending through the tube wall of the support member 1411, and a liquid substrate in the liquid guide channel 1410 may flow to the liquid guide layer 1412 through the liquid guide hole 1415. The shape of the liquid guide hole 1415 is not limited herein, and includes, but is not limited to, a circle, an ellipse, a long strip, a square, or the like.

In this embodiment, there are a plurality of liquid guide holes 1415, and each liquid guide hole 1415 is a long-strip hole extending in the axial direction of the support member 1411. The plurality of liquid guide holes 1415 are evenly distributed in the peripheral direction of the support member 1411, to ensure that the support member 1411 has sufficient liquid supply area and even liquid supply. Certainly, in other embodiments, the extension direction of the long-strip hole may alternatively be obliquely disposed at an angle with the axial direction of the support member 1411. In some other embodiments, the plurality of liquid guide holes 1415 may be evenly distributed in the axial direction and the peripheral direction of the support member 1411 in a lattice pattern.

The support member 1411 has specific mechanical strength, to provide specific support strength for the liquid guide layer 1412 and the heating portion 142. In some embodiments, the support member 1411 may be made of a metal material, for example, a metal material such as stainless steel, an aluminum alloy, or a brass alloy. The metal material has advantages such as high-temperature resistance, no pollution, no odor, and the like. In addition, size precision and errors of the metal material can be well controlled during processing, facilitating control of the size of the support member 1411 during manufacturing, so that the processing precision of the support member 1411 is higher, and the support member 1411 can be fabricated to be extremely thin. In addition, the metal material has a specific heat conduction property, to improve atomization efficiency of the atomization core 14. Certainly, in other embodiments, the support member 1411 may alternatively be made of glass, ceramic, hard plastics, and other materials.

In some embodiments, the liquid guide layer 1412 may include a heat conduction layer 1413 and an isolation layer 1414. The isolation layer 1414 may be sleeved outside the heat conduction layer 1413 and is in contact with the heating portion 142, and is configured to isolate the heat conduction layer 1413 from the heating portion 142. The liquid substrate in the liquid guide channel 1410 may be guided to the heating portion 142 through the liquid guide hole 1415, the heat conduction layer 1413, and the isolation layer 1414 in sequence. After being powered on to generate heat, the heating portion 142 heats and atomizes the liquid substrate to generate an aerosol. The heat conduction layer 1413 has a relatively high heat conduction coefficient. The isolation layer 1414 can transfer partial heat generated by the heating portion 142 to the heat conduction layer 1413. The heat conduction layer 1413 can conduct the heat to a near liquid substrate more rapidly. After being heated, the liquid substrate near the heat conduction layer 1413 exhibits reduced viscosity, so that fluidity of the liquid substrate near the heat conduction layer 1413 is improved, thereby improving a heat conduction effect of the atomization core 14 and change of air.

In some embodiments, the heat conduction layer 1413 may be made of one or more metal materials such as stainless steel, nickel, a nickel alloy, aluminum, an aluminum alloy, copper, and a copper alloy. The metal material has a good heat conduction property, and size precision and processing errors can be well controlled during processing. In some embodiments, the heat conduction layer 1413 is a metal mesh layer, and the liquid substrate is guided through a porous structure of the metal mesh layer. It may be understood that when the structural strength of the heat conduction layer 1413 is sufficient, the atomization core 14 may alternatively not include the support member 1411.

Certainly, in other embodiments, the heat conduction layer 1413 may alternatively be made of a non-metal material having a good heat conduction coefficient.

The isolation layer 1414 may be a cotton layer, and a specific material of the cotton layer is not limited. For example, the material may be natural organic cotton, or may be synthetic organic polymer porous foam cotton. The cotton layer can stably store a partial liquid substrate, and rapidly guide the liquid substrate to the heating portion 142. In addition, when the heat conduction layer 1413 is a metal material, the isolation layer 1414 may further isolate the heat conduction layer 1413 from the heating portion 142, to avoid electrical connection between the heating portion 142 and the heat conduction layer 1413, thereby improving safety performance of the atomizer 100.

It may be understood that, in other embodiments, the liquid guide layer 1412 is not limited to the foregoing specific structure. For example, in some embodiments, there are a plurality of heat conduction layers 1413 and isolation layers 1414. The heat conduction layers 1413 and the isolation layers 1414 may be alternately disposed, or a plurality of isolation layers 1414 are disposed between every two adjacent heat conduction layers 1413, or a plurality of heat conduction layers 1413 are disposed between every two adjacent isolation layers 1414. In some other embodiments, there may alternatively be one heat conduction layer 1413 and a plurality of isolation layers 1414; or there may be a plurality of heat conduction layers 1413 and one isolation layer 1414. In some other embodiments, the heat conduction layer 1413 and the isolation layer 1414 may be woven together to form a composite liquid guide layer, for example, metal and cotton are woven together to form a composite liquid guide layer. Certainly, the liquid guide layer 1412 may alternatively include only the cotton layer and not include the heat conduction layer 1413.

The second atomization base 15 is disposed in the housing 12, and may be an independent component, or may be integrally formed with the air outlet tube 16 or the housing 12. In this embodiment, the second atomization base 15 is integrally formed with the housing 12 by injection molding. The lower end of the air outlet tube 16 is embedded in the second atomization base 15 and is in communication with the atomization cavity 150. A gap is formed between two lateral sides of the second atomization base 15 parallel to the axial direction of the atomization core 14 and the inner wall surface of the housing 12, forming a liquid flowing space for the liquid substrate to enter the liquid guide channel 1410. The other two lateral sides of the second atomization base 15 are integrally formed with the inner wall surface of the housing 12.

In some embodiments, at least one liquid flowing channel 151 communicating the liquid storage cavity 120 with the liquid guide portion 141 may be further formed on the second atomization base 15. The cross-sectional area of the liquid flowing channel 151 is less than the cross-sectional area of the liquid guide channel 1410. When the atomization core 14 normally operates, the liquid substrate is mainly supplied to the heating portion 142 through the liquid guide channel 1410. When bubbles are stuck in the atomization core 14, the bubbles are stuck at the two ends of the liquid guide channel 1410. Consequently, the liquid substrate cannot enter the liquid guide channel 1410. However, the liquid flowing channel 151 may not be obstructed by the bubbles. The liquid substrate in the liquid storage cavity 120 may be added to the liquid guide portion 141 through the liquid flowing channel 151, to avoid scorching. Meanwhile, the liquid flowing channel 151 is directly in communication with the external surface of the liquid guide portion 141. When the liquid flowing channel 151 is closer to the atomization cavity 150 or the heating portion 142, the liquid substrate has a higher temperature and a lower viscosity, so that the liquid substrate has higher fluidity, and the liquid substrate can be quickly added to the liquid guide portion 141.

The liquid flowing channel 151 may be formed by recessing the outer wall surface of the second atomization base 15, and one end of the liquid flowing channel 151 may be in communication with the pressing groove 1540, to further communicate with the outer surface of the liquid guide portion 141. In this embodiment, the liquid flowing channel 151 extends longitudinally downward from the top of the outer wall surface of the second atomization base 15 to communicate with the pressing groove 1540.

In addition, in this embodiment, there are two liquid flowing channels 151, and the two liquid flowing channels 151 are respectively in communication with two pressing portions 1416 at the two ends of the liquid guide portion 141, thereby improving a liquid supply effect. Certainly, in other embodiments, there may alternatively be one or more than two liquid flowing channels 151.

The cross-sectional dimension of each liquid flowing channel 151 may be designed based on the viscosity of the liquid substrate. Usually, to ensure stable liquid flowing, a higher viscosity of the liquid substrate indicates a larger cross-sectional dimension of the liquid flowing channel 151. For example, for a liquid substrate having a low viscosity (for example, the viscosity is approximately less than 10 W), the width of the liquid flowing channel 151≥1.2 mm. For a liquid substrate having a medium viscosity (for example, the viscosity ranges from 10 W to 100 W), the width of the liquid flowing channel 151≥1.8 mm. For a liquid substrate having a medium-to-high-viscosity (for example, the viscosity ranges from 100 W to 500 W), the width of the liquid flowing channel 151≥2.5 mm. For a liquid substrate having a viscosity of 400 W, the width of the liquid flowing channel 151 ranges from 3 mm to 4 mm.

On the other hand, the cross-sectional dimension of the liquid flowing channel 151 is improper to be excessively large; otherwise, the contour size of the product is increased. In some embodiments, a width of the cross section of each liquid flowing channel 151 may range from 0.6 mm to 2.5 mm, and a depth of each liquid flowing channel 151 may range from 0.5 mm to 1.0 mm.

In addition, because the liquid substrate is supplied to the liquid flowing channel 151 from the pressing portions 1416 at the two ends of the liquid guide portion 141, the pressing portions 1416 are improper to be excessively tight or excessively long; otherwise, liquid supply is difficult. However, if the pressing portion 1416 is excessively loose or excessively narrow, liquid leakage is easily caused.

Generally, the outer diameter of the pressing portion 1416 may approximately range from 1.5 mm to 5 mm. A difference between the outer diameter of the pressing portion 1416 and the hole diameter of the clamping slot 140 may range from −0.2 mm to 0.6 mm (for example, the outer diameter of the pressing portion 1416 is approximately 2.4 mm, and the hole diameter of the clamping slot 140 ranges from 1.8 mm to 2.6 mm), and the length (that is, the length in the axial direction of the atomization core 14) of each pressing portion 1416 may range from 0.8 mm to 2.5 mm. The two dimensions are mutually matched and balanced, so that a good liquid supply effect and a good liquid leakage preventing effect can be achieved.

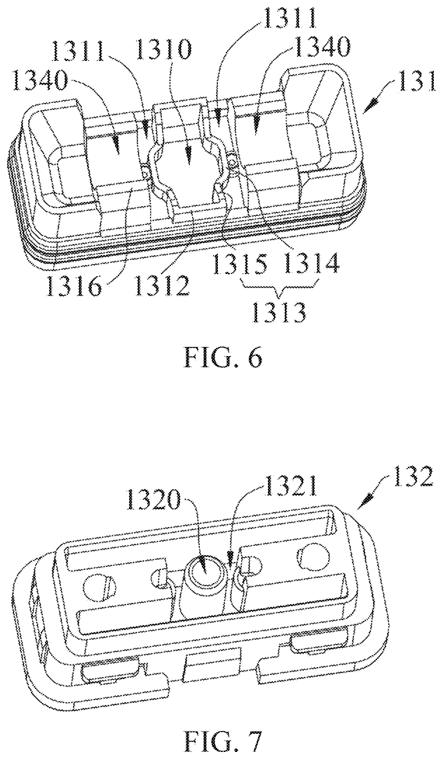

With reference to FIG. 3 to FIG. 7, the first atomization base 13 may include a base 132 and a sealing sleeve 131 sleeved on the base 132. The sealing sleeve 131 may be made of an elastic material such as silicone. The outer wall surface of the sealing sleeve 131 made of an elastic material is at least partially in sealing fit with the inner wall surface of the housing 12, so that the lower opening of the liquid storage cavity 120 can be reliably sealed, thereby preventing liquid leakage. In addition, the pressing groove 1340 is formed on the sealing sleeve 131, and the atomization core 14 is clamped between the sealing sleeve 131 and the second atomization base 15. The elastic property of the sealing sleeve 131 can provide a buffer space, avoiding damage to the atomization core 14 due to rigid clamping, and can further improve sealing between the pressing portion 1416 of the atomization core 14 and the pressing groove 1340.

The base 132 may be made of a hard material such as plastic, and is configured to improve the structural strength of the first atomization base 13. In some embodiments, the first atomization base 13 may further include two electrode columns 133 embedded in the base 132. The two electrode leads 143 of the atomization core 14 are respectively connected to the two electrode columns 133, and are further connected to the power supply device 200 through the two electrode columns 133. Certainly, in other embodiments, the quantity of the electrode columns 133 is not limited to two, and may alternatively be one or more than two.

An air inlet 1320 communicating the atomization cavity 150 with the outside may be further formed on the base 132. In this embodiment, one air inlet 1320 is provided and is coaxially disposed with the base 132, but is not limited to being coaxially disposed. Certainly, in other embodiments, there may alternatively be a plurality of air inlets 1320. The cross-sectional shape of the air inlet 1320 is not limited, for example, may be a circle, an ellipse, a square, and other shapes.

Correspondingly, a vent hole 1310 communicating the air inlet 1320 with the atomization cavity 150 is formed on the sealing sleeve 131. The air inlet 1320, the vent hole 1310, and the atomization cavity 150 may be in communication in sequence from bottom to top, and may be coaxially disposed. The cross-sectional shape of the vent hole 1310 is not limited, for example, may be a circle, an ellipse, a square, and other shapes. The cross-sectional shapes of the vent hole 1310 and the air inlet 1320 may be the same or may be different.

In some embodiments, at least one first liquid storage groove 1311 may be further formed by recessing the upper surface (that is, the surface of the side facing the atomization cavity 150) of the sealing sleeve 131. The first liquid storage groove 1311 is located below the atomization portion 1417 of the atomization core 14, and can catch a leaked liquid or a condensate flowing down from the atomization core 14. In addition, the first liquid storage groove 1311 is further in communication with the atomization core 14, and the liquid substrate stored in the first liquid storage groove 1311 can be further absorbed back to the atomization core 14 for atomization again, thereby achieve high-efficient use of the liquid substrate.

Specifically, the sealing sleeve 131 includes two abutting portions 1316, two pressing grooves 1340 are respectively formed on the two abutting portions 1316, and the two ends of the atomization core 14 are respectively mounted in the two pressing grooves 1340 of the two abutting portions 1316. The at least one first liquid storage groove 1311 is formed between two abutting portions 1316, that is, two surfaces of two abutting portions 1316 that are disposed opposite to each other define a part of a boundary of the at least one first liquid storage groove 1311.

Further, the sealing sleeve 131 further includes an annular protrusion 1312 located between the two abutting portions 1316. The inner wall surface of the annular protrusion 1312 defines the vent hole 1310, and the outer wall surface of the annular protrusion 1312 defines the part of the boundary of the at least one first liquid storage groove 1311. Specifically, in this embodiment, the annular protrusion 1312 may include two side walls 1313 disposed opposite to each other in the axial direction of the atomization core 14. A first liquid storage groove 1311 is formed between the outer wall surface of each side wall 1313 and a corresponding abutting portion 1316.

A depth of the first liquid storage groove 1311 is improper to be excessively large; otherwise, it is difficult for the liquid substrate in the first liquid storage groove 1311 to flow back to the atomization core 14. Certainly, the depth of the first liquid storage groove 1311 is improper to be excessively small; otherwise, a liquid storage space of the first liquid storage groove 1311 is excessively small. In some embodiments, the depth of the first liquid storage groove 1311 may range from 1 mm to 3 mm. The distance between the first liquid storage groove 1311 and the atomization core 14 is relatively small, so that the liquid substrate in the first liquid storage groove 1311 can flow back to the atomization core 14 under a capillarity action, thereby improving a flow-back effect.

By disposing the first liquid storage groove 1311, the atomizer 100 can achieve a good liquid leakage preventing effect and achieve high-efficient use of the liquid substrate in different operating states or operating environments. Details are described as follows.

When sufficient liquid is supplied to the atomization core 14, the liquid substrate is supplied from the two ends to the middle of the atomization core 14. Consequently, during inhalation, a small amount of the liquid substrate flows downwards. In this case, the first liquid storage groove 1311 can catch the small amount of the liquid substrate, and draw the small amount of the liquid substrate back to the atomization core 14 for atomization again, thereby achieving the high-efficient use of the liquid substrate.

When the atomizer 100 switches from a low-temperature environment to a high-temperature environment, air in the liquid storage cavity 120 may expand due to the temperature increase. Consequently, a positive pressure is formed in the liquid storage cavity 120. The positive pressure squeezes the liquid substrate out of the liquid storage cavity 120 to form leakage. The leaked liquid substrate is stored in the first liquid storage groove 1311. During inhalation, the liquid substrate stored in the first liquid storage groove 1311 is first consumed. Alternatively, when the temperature of the atomizer 100 decreases, a negative pressure in the liquid storage cavity 120 draws the liquid substrate stored in the first liquid storage groove 1311 back to the liquid storage cavity 120.

During inhalation, the atomization core 14 has a slight liquid spit-back phenomenon, and a spit-back liquid can also be collected in the first liquid storage groove 1311. In addition, when there are a relatively large number of inhalations, a condensate is generated in the air outlet channel 160. When the atomizer 100 is vertically placed, the condensate is flowed back to the atomization cavity 150, and is further caught by the first liquid storage groove 1311 located below the atomization cavity 150.

A second liquid storage groove 1321 may also be formed by recessing on the upper surface (that is, the surface of the side facing the atomization cavity 150) of the base 132. The second liquid storage groove 1321 is located below the first liquid storage groove 1311. When the liquid storage space of the first liquid storage groove 1311 is insufficient and causes leakage of the liquid substrate, the liquid substrate can be caught by the second liquid storage groove 1321, thereby further improving the liquid leakage preventing effect. For example, when the atomizer 100 switches from a low-temperature environment to a high-temperature environment and a temperature difference is large, a relatively large amount of liquid substrate leaks from the liquid storage cavity 120, causing that the liquid storage space of the first liquid storage groove 1311 is insufficient for use. In this case, redundant liquid substrate flows downward to the second liquid storage groove 1321. A depth of the second liquid storage groove 1321 may be greater than or equal to 3 mm, so that the second liquid storage groove 1321 has a relatively large liquid storage space.

The second liquid storage groove 1321 may surround outside the air inlet 1320, and may be coaxially disposed with the air inlet 1320. A height of the air inlet 1320 protruding from a bottom surface of the second liquid storage groove 1321 is greater than or equal to the depth of the second liquid storage groove 1321, thereby preventing the liquid substrate in the second liquid storage groove 1321 from flowing to the air inlet 1320 to block the air inlet 1320 to affect inhalation, or flowing out through the air inlet 1320 to cause liquid leakage.

Further, a projection of at least a partial cross-sectional contour of the vent hole 1310 (that is, the at least partial inner contour of the cross section of the annular protrusion 1312) on the base 132 in the vertical direction is located outside the air inlet 1320, to prevent the liquid substrate in the first liquid storage groove 1311 from flowing to the air inlet 1320 when the liquid substrate flows downward. In addition, the cross-sectional area of the vent hole 1310 may be further greater than the cross-sectional area of the air inlet 1320, so that air flow from the air inlet 1320 can smoothly enter the atomization cavity 150 through the vent hole 1310.

In addition, a projection of at least a partial inner contour of a cross section of the annular protrusion 1312 on the base 132 in a vertical direction is located in the second liquid storage groove 1321, so that the liquid substrate in the first liquid storage groove 1311 can be caught by the second liquid storage groove 1321 when the liquid substrate flows downward. When the atomizer 100 is inverted, due to disposition of the first liquid storage groove 1311, blocking caused by the liquid substrate in the second liquid storage groove 1321 flowing to the air outlet tube 16 can be further prevented.

Specifically, in this embodiment, each side wall 1313 includes a middle part 1314 and two edge parts 1315 respectively located at two ends of the middle part 1314. A height of the middle part 1314 protruding from the bottom surface of the first liquid storage groove 1311 is less than a height of the edge part 1315 protruding from the bottom surface of the first liquid storage groove 1311, so that the height of the middle part 1314 determines the depth of the first liquid storage groove 1311. The projection of the inner wall surface of the middle part 1314 on the base 132 is located in the second liquid storage groove 1321 and is located outside the air inlet 1320. In this way, when the liquid storage space of the first liquid storage groove 1311 is insufficient to cause leakage of the liquid substrate, the liquid substrate flows downward along the middle part 1314 and is caught by the second liquid storage groove 1321, and does not flow to the air inlet 1320.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. An atomizer, comprising:
a housing having a liquid storage cavity formed therein;
a first atomization base at least partially disposed in the housing;
a second atomization base disposed in the housing, an atomization cavity being formed between the second atomization base and the first atomization base; and
an atomization core at least partially disposed in the atomization cavity,
wherein at least one first liquid storage groove is formed on the first atomization base, and
wherein the at least one first liquid storage groove is located below the atomization cavity.

2. The atomizer of claim 1, wherein the first atomization base comprises two abutting portions,
wherein two ends of the atomization core are respectively disposed on the two abutting portions, and
wherein two surfaces of the two abutting portions that are disposed opposite to each other define a part of a boundary of the at least one first liquid storage groove.

3. The atomizer of claim 2, wherein a depth of the at least one first liquid storage groove ranges from 1 mm to 3 mm.

4. The atomizer of claim 2, wherein the first atomization base comprises an annular protrusion located between the two abutting portions,
wherein an inner wall surface of the annular protrusion defines a vent hole in communication with the atomization cavity, and
wherein an outer wall surface of the annular protrusion defines a part of the boundary of the at least one first liquid storage groove.

5. The atomizer of claim 4, wherein the first atomization base comprises a base and a sealing sleeve sleeved on the base, and
wherein the at least one first liquid storage groove is formed on the sealing sleeve.

6. The atomizer of claim 5, wherein a second liquid storage groove and an air inlet that communicates the vent hole with outside are formed on the base.

7. The atomizer of claim 6, wherein the second liquid storage groove surrounds outside the air inlet, and
wherein a height of the air inlet protruding from a bottom surface of the second liquid storage groove is greater than or equal to a depth of the second liquid storage groove.

8. The atomizer of claim 6, wherein a projection of at least a partial inner contour of a cross section of the annular protrusion on the base in a vertical direction is located in the second liquid storage groove.

9. The atomizer of claim 6, wherein the annular protrusion comprises two side walls disposed opposite to each other in an axial direction of the atomization core,
wherein each side wall comprises a middle part and two edge parts respectively located at two ends of the middle part,
wherein a height of the middle part is less than a height of the edge parts, and
wherein a projection of an inner wall surface of the middle part on the base is located in the second liquid storage groove.

10. An electronic atomization device, comprising:
the atomizer of claim 1; and
a control circuit electrically connected to the atomizer.

11. The electronic atomization device of claim 10, wherein the first atomization base comprises two abutting portions,
wherein two ends of the atomization core are respectively disposed on the two abutting portions, and
wherein two surfaces of the two abutting portions that are disposed opposite each other define a part of a boundary of the at least one first liquid storage groove.

12. The electronic atomization device of claim 11, wherein a depth of the at least one first liquid storage groove ranges from 1 mm to 3 mm.

13. The electronic atomization device of claim 11, wherein the first atomization base comprises an annular protrusion located between the two abutting portions,
wherein an inner wall surface of the annular protrusion defines a vent hole in communication with the atomization cavity, and
wherein an outer wall surface of the annular protrusion defines a part of the boundary of the at least one first liquid storage groove.

14. The electronic atomization device of claim 13, wherein the first atomization base comprises a base and a sealing sleeve sleeved on the base, and
wherein the at least one first liquid storage groove is formed on the sealing sleeve.

15. The electronic atomization device of claim 14, wherein a second liquid storage groove and an air inlet that communicates the vent hole with an outside are formed on the base.

16. The electronic atomization device of claim 15, wherein the second liquid storage groove surrounds an outside of the air inlet, and
wherein a height of the air inlet protruding from a bottom surface of the second liquid storage groove is greater than or equal to a depth of the second liquid storage groove.

17. The electronic atomization device of claim 15, wherein a projection of at least a partial inner contour of a cross section of the annular protrusion on the base in a vertical direction is located in the second liquid storage groove.

18. The electronic atomization device of claim 15, wherein the annular protrusion comprises two side walls disposed opposite each other in an axial direction of the atomization core,
wherein each side wall of the two side walls comprises a middle part and two edge parts respectively located at two ends of the middle part,
wherein a height of the middle part is less than a height of the two edge parts, and
wherein a projection of an inner wall surface of the middle part on the base is located in the second liquid storage groove.
